(19) United States
(12) Patent Application Publication
(10) Pub. No.: US 2009/0300757 A1
(43) Pub. Date: Dec. 3, 2009

(54) IMAGE FORMING APPARATUS PERFORMING USER AUTHENTICATION USING A CARD

(75) Inventors: Shun Tanaka, Kanagawa (JP); Yuuki Ohtaka, Kanagawa (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/471,527

(22) Filed: May 26, 2009

(30) Foreign Application Priority Data
May 30, 2008 (JP) 2008-143134
May 30, 2008 (JP) 2008-143135

(51) Int. Cl. H04L 9/32

(52) U.S. Cl. 726/20

(57) ABSTRACT

An image forming apparatus includes an ID acquisition part configured to acquire a card ID readable by a card reader. A correspondence information management part manages correspondence information between the card ID and user identification information. A user information acquisition part acquires the user identification information corresponding to the card ID acquired by the card ID acquisition part from the correspondence information management part, and acquires a password of a user corresponding to the acquired user identification information. An authentication control part causes an authentication process of the user to be executed in accordance with the acquired user identification information and the acquired password.

### BACKGROUND OF THE INVENTION

1. Field of the Invention

The present invention generally relates to an image forming apparatus and, more particularly, to an image forming apparatus performing user authentication using a card.

2. Description of the Related Art

In recent years, many image forming apparatuses have been equipped with an interface for connecting to an external device such as a USB (Universal Serial Bus) device. When performing user authentication in such an image forming apparatus, a solution is developed to cause a user to input user information through an external device, such as, for example, a card reader (for example, refer to Patent Documents 1 through 3).

When using a card for user authentication, it is desirable, from a viewpoint of acquiring high security, to use a highly functional IC card combined with PIN (Personal Identification Number). This is because one cannot acquire information unless a correct PIN is input from such an IC card.

Patent Document 1: Japanese Laid-Open Patent Application, No. 2006-215770

Patent Document 2: Japanese Laid-Open Patent Application, No. 2007-122384

Patent Document 3: Japanese Laid-Open Patent Application, No. 2006-92437.

In order to use information stored in a highly functional IC card for user authentication, a card format (an information recording format) must be disclosed by an issuer of the IC card. However, the card format is very important information with respect to security and the issuer does not disclose the card format easily. Thus, it has been necessary to take an inconvenient and complicated action to build a system using an IC card.

On the other hand, there are many other simple cards having a card IC without using SIN, such as, for example, a magnetic card and a Proximity card. However, it is difficult for such a simple card to maintain the same high security as that acquired by a highly functional IC card.

In the meantime, in a multi-purpose information processing apparatus having versatility and a high processing capability, such as a personal computer, a device driver program for controlling an external device such as a USB device may be pre-installed in an operating system (OS), or a device driver program may be provided by a manufacturer of the external device for free. Accordingly, in such an information processing apparatus, an external device, which is connectable to the information processing apparatus, can be changed arbitrarily and easily.

However, in a built-in type apparatus such as an image forming apparatus, a device driver program and a program for inputting and outputting arbitrary information using the device driver program are factory-installed, and it is difficult to change a usable external device. Accordingly, in the technique disclosed in the above-mentioned Patent Documents, an external device usable for user authentication is fixed and limited to a particular device.

### SUMMARY OF THE INVENTION

It is a general object of the present invention to provide an improved and useful image forming apparatus in which the above-mentioned problems are eliminated.

A more specific object of the present invention is to provide an image forming apparatus and an authentication control method, which can realize an appropriate user authentication using a card.

Another object of the present invention is to provide an image forming apparatus and an external device management method, which can improve flexibility in connection of an external device to the image forming apparatus.

In order to achieve the above-mentioned objects, there is provided according to one aspect of the present invention an image forming apparatus comprising: an ID acquisition part configured to acquire a card ID readable by a card reader; a correspondence information management part configured to manage correspondence information between the card ID and user identification information; a user information acquisition part configured to acquire the user identification information corresponding to the card ID acquired by the card ID acquisition part from the correspondence information management part, and acquire a password of a user corresponding to the acquired user identification information; and an authentication control part configured to cause an authentication process of the user to be executed in accordance with the acquired user identification information and the acquired password.

There is provided according to another aspect of the present invention an authentication control method performed by an image forming apparatus, comprising: acquiring a card ID readable by a card reader; acquiring user identification information corresponding to the acquired card ID from a correspondence information management part, which is configured to manage the correspondence information between the card ID and the user identification information, and acquiring a password corresponding to the acquired user identification information; and causing an authentication process of the user to be executed in accordance with the acquired user identification information and the acquired password.

Other objects, features and advantages of the present invention will become more apparent from the following detailed description when read in conjunction with the accompanying drawings.

### BRIEF DESCRIPTION OF THE DRAWINGS

FIG. 1 is a block diagram of a hardware structure of an image forming apparatus according to an embodiment of the present invention;

FIG. 2 is a block diagram illustrating a software structure of the image forming apparatus;

FIGS. 3A and 3B are parts of a flowchart of a process procedure of an authentication process;

FIG. 4 is an illustration of display screens when the authentication process is being performed;

FIG. 5 is an illustration of an example of correspondence information, which a correspondence information management part manages;

FIG. 6 illustrates an example of display of a card ID registration screen;

FIG. 7 is an illustration of a card validity registration screen;

FIG. 8 is an illustration of tables used for an access control of functions of the image forming apparatus;

FIG. 9 is a block diagram of a software structure of an image forming apparatus according to a second embodiment of the present invention;

FIG. 10 is a block diagram of the image forming apparatus in which a plurality of device driver programs are installed;

FIG. 11 is a flowchart of an editing process of a management table;

FIG. 12 is an illustration of a first example of display of the management table;

FIG. 13 is an illustration of a second example of display of the management table;

FIG. 14 is an illustration of a third example display of the management table;

FIG. 15 is an illustration of a fourth example of display of the management table;

FIG. 16 is a flowchart of a process of connecting an external device; and

FIG. 17 is a block diagram of a software structure of the image forming apparatus illustrating a process procedure for acquiring information from the external device.

### DETAILED DESCRIPTION OF THE PREFERRED EMBODIMENTS

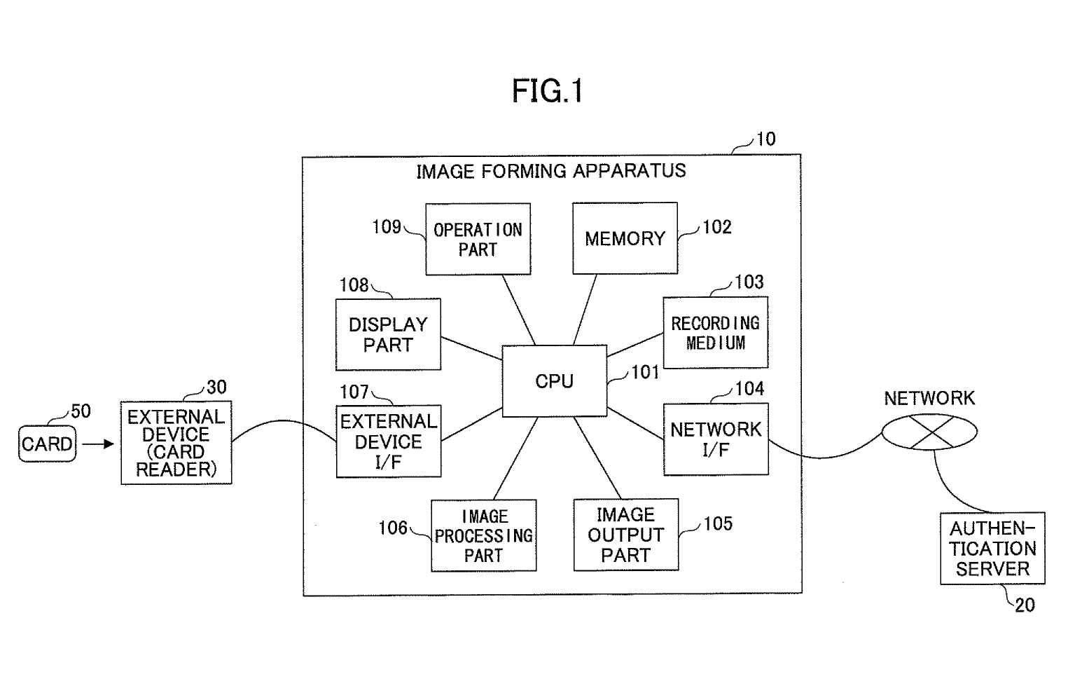

A description will be given below, with reference to the drawings, of an embodiment of the present invention. FIG. 1 is a block diagram of a hardware structure of an image forming apparatus according to an embodiment of the present invention.

The image forming apparatus 10 illustrated in FIG. 1 is a multi-function machine, which realizes a plurality of functions such as a scanning function, a copying function, a printing function, etc., by a single unit. The image forming apparatus 10 includes a CPU 101, a memory 102, a recording medium 103, a network I/F 104, an image output part 105, an image processing part 106, an external device interface (I/F) 107, a display part 108, and an operation part 109.

Programs for realizing the functions of the image forming apparatus 10 are stored or installed in the recording medium 103, which is a non-volatile recording medium such as, for example, a hard disk drive (HDD). The recording medium 103 stores the installed programs and also stores necessary files and data. The memory 102 stores the programs read from the recording medium 103 when a boot-up instruction of the programs is made. The CPU 101 realizes the functions of the image forming apparatus 10 according to the programs temporarily stored in the memory 102. The network I/F 104 is used as an interface for connecting to a network.

The display part 108 includes a liquid crystal display (LCD) to display an operation screen and messages. The operation part 109 is an input part, which includes keys to be operated by a user in order to receive an input operation by the user. The display part 108 and the operation part 109 may be integrated into a single part as an operation panel.

The image processing part 106 performs various kinds of image processing when outputting (printing) image data. The image output part 105 outputs (prints) image data.

The external device I/F 107 is an interface for connecting to an external device 30 such as, for example, a card reader used for inputting user information for authentication. A plurality of external devices may be connectable to the external device I/F 107. The external device I/F 107 includes, for example, a USB port (USB host interface) or a serial port. In the present embodiment, the external device 30 is a so-called card reader, which reads information from a card 50. The external device 30 includes a hardware interface (for example, a USB connector or a serial interface) which is connectable with the external device I/F 107. The external device 30 may be built in the image forming apparatus 10. In the present embodiment, a card reader is used as the external device 30, and, hereinafter, the external device 30 is referred to as a card reader 30. The card reader 30 can be of a contact type or a non-contact type. A card 50 storing user information for authentication is set to the card reader 30. The card 50 is not limited to an IC card, and may be a magnetic card which can store a card ID (card number) unique to each card 50. Generally, the card ID is referred to as a universal ID or a card serial number. Specifically, the card 50 may be, for example, a proximity card, a Mifare card, a Java (registered trademark) card, etc.

In the present embodiment, it is supposed that the card 50 is distributed to each user. However, one piece of the card 50 may be shared by a plurality of users in accordance with a security level required for operation. The card 50 distributed to each user is not limited to one kind. The card reader 30 is connectable with the image forming apparatus 10 simply by a USB or the like, as mentioned above. Therefore, a plurality of different card readers 30, which handle the cards 50 of different kinds, such as a proximity card, a Mifare card, a Java (registered trademark), etc., may be connected to the image forming apparatus 10 simultaneously. In such a case, a plurality of kinds of cards 50 can be used simultaneously.

In FIG. 1, the image forming apparatus 10 is connected with an authentication server 20 through a network (wired or wireless). The authentication server 20 includes a computer, which performs authentication of a user according to an authentication method based on a user ID and a password, such as a lightweight directory access protocol (LDAP), the Windows (registered trademark) authentication, the Kerberos, etc. The authentication server 20 includes a user information database in which correspondence information between a user ID and a password is stored. The authentication server 20 executes an authentication process by checking correspondence information stored in the user information database with the user ID and the password input through an authentication request. The user ID is user identification information for uniquely identifying each user, and is information generally referred to as a user name.

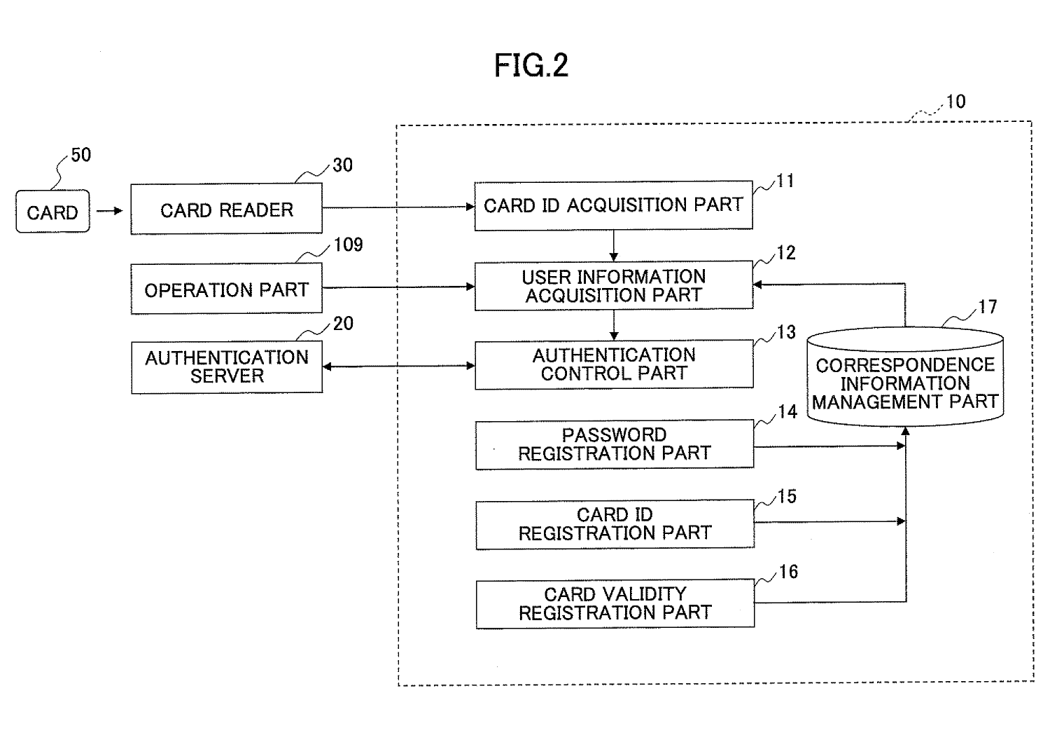

FIG. 2 is a block diagram illustrating a software structure of the image forming apparatus 10 according to the present embodiment. As illustrated in FIG. 2, the image forming apparatus 10 includes a card ID acquisition part 11, a user information acquisition part 12, an authentication control part 13, a password registration part 14, a card ID registration part 15, a card validity registration part 16, and a correspondence information management part 17. Each of the above-mentioned parts is software realized by a process which the program installed in the image forming apparatus 10 causes the CPU 101 to perform.

The card ID acquisition part 11 acquires the card ID, which the card reader 30 reads from the card 50, from the card reader 30. The user information acquisition part 12 acquires the user ID corresponding to the card ID acquired by the card ID acquisition part 11 from the correspondence information management part 17, and also acquires the password input by the user through the operation part 109. That is, the correspondence information management part 17 includes a memory area in the recording medium 103, which manages the correspondence information between the card ID and the user information. The authentication control part 13 causes the authentication server 20 to perform an authentication process based on the user ID and the password, which are acquired by the user information acquisition part 12. The password registration part 14 registers the password in the correspondence information management part 12 in relation to the card ID for the purpose of eliminating inconvenience caused by inputting the password each time the authentication process is performed. Accordingly, when the password is registered in the correspondence information management part 17, the user information acquisition part 12 acquires the password corresponding to the card ID not from the operation part 109 but from the correspondence information management part 17. The card ID registration part 15 registers the card ID in the correspondence information management part 17 according to an operation instruction made by the user. The card validity registration part 16 registers information (card validity) indicating validity of the card 50 in the correspondence information management part 17 in relation to the card ID according to an operation instruction made by the user. If the card 50 is invalid, the authentication using the card 50 is invalidated.

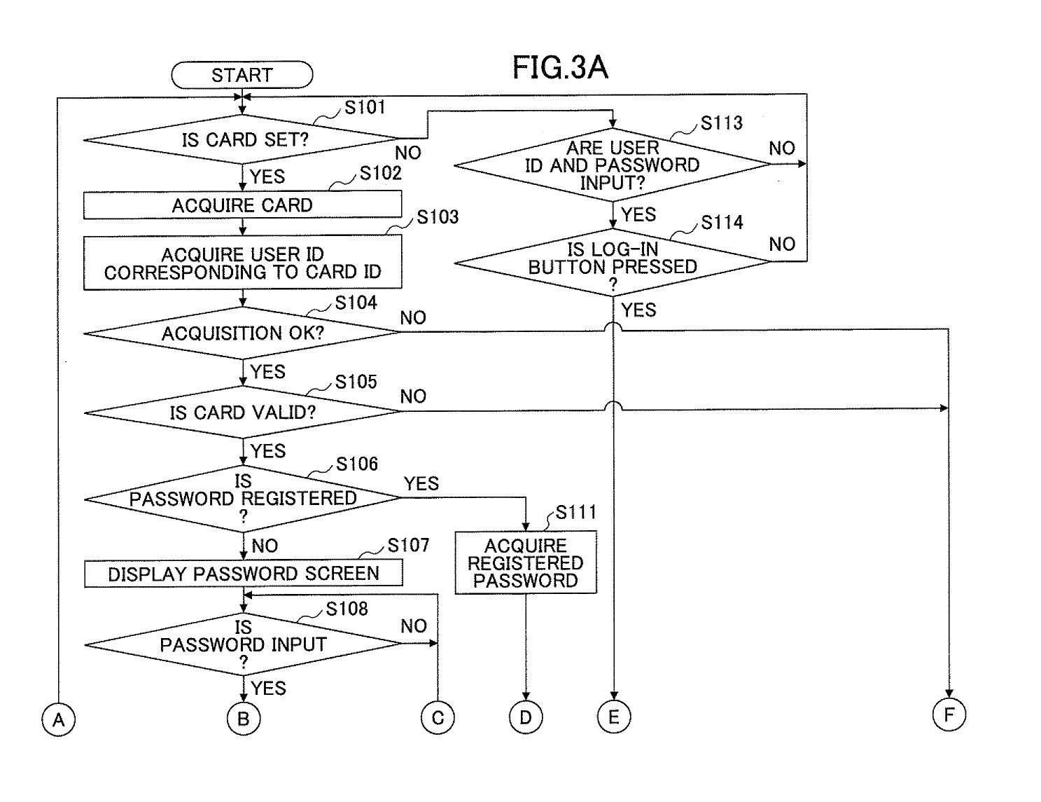

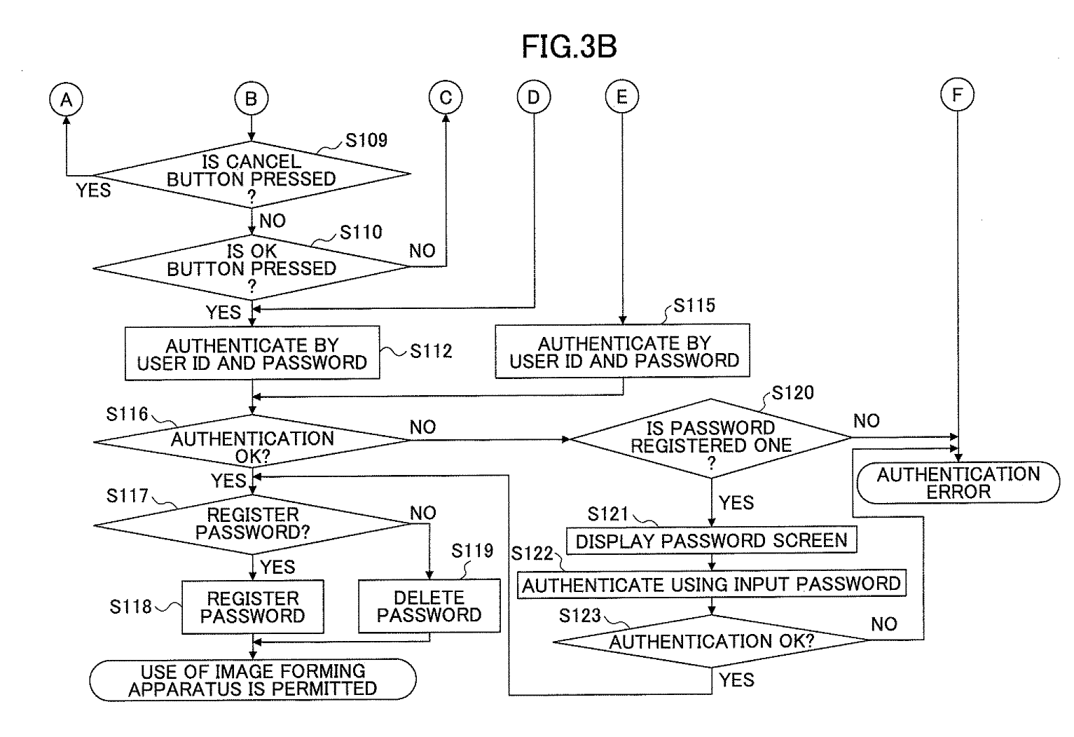

A description will be given below of a process procedure of the authentication process performed by the image forming apparatus 10. FIGS. 3A and 3B are parts of a flowchart of the process procedure of the authentication process. FIG. 4 is an illustration of display screens when the authentication process is being performed.

In a state where the user information acquisition part 12 causes the display part 108 to display a log-in screen 510 (refer to FIG. 4), if the card 50 is set to the card reader 30 by the user (YES of S101), the card ID acquisition part 11 acquires the card ID, which the card reader 30 reads from the card, from the card reader 30 (S102). The setting of the card 50 to the card reader 30 means causing the card 50 to be in a state where the card reader 30 can read information recorded on the card 50, such as insertion of the card 50 into the card reader 30 or positioning the card 50 in the vicinity of the card reader 30.

Then, the user information acquisition part 12 acquires the user ID corresponding to the acquired card ID (hereinafter, referred to as “current card ID”) from the correspondence information management part 17 (S103).

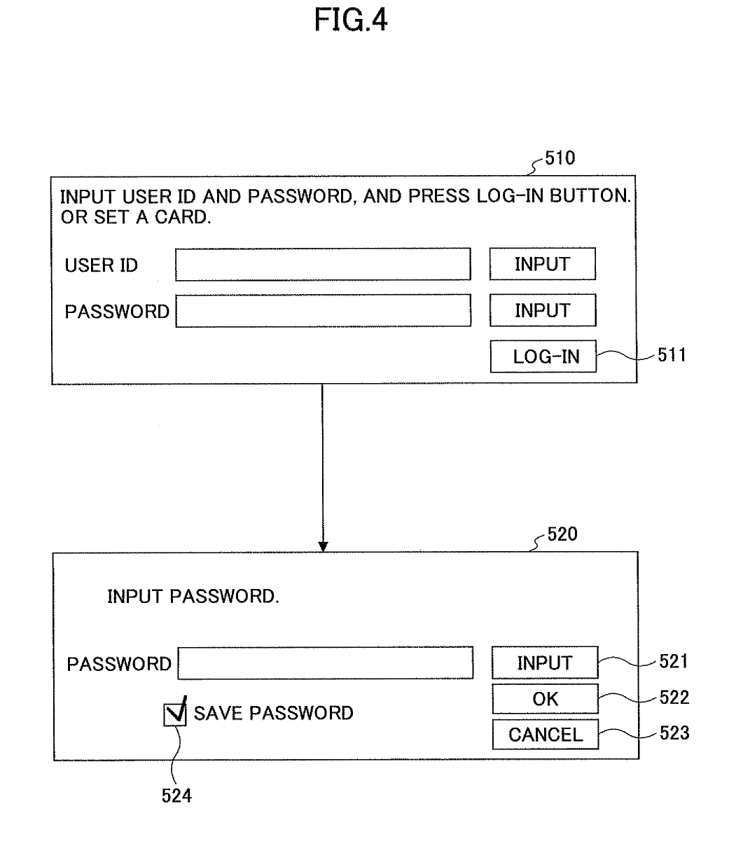

FIG. 5 is an illustration of an example of the correspondence information, which the correspondence information management part 17 manages. In FIG. 5, the correspondence information 170 is information for retaining the user ID, the card ID, the password, and the card validity for each user by relating them to each other. Accordingly, in step S103, the user information acquisition part 12 acquires the user ID related to the current card ID from the correspondence information management part 17.

The password is not necessarily registered in the correspondence information management part 17. If the password is registered with respect to the current card ID, the user information acquisition part 12 causes the log-in screen 510 to display a sign (for example, “*********”) in a password input column indicating that there is no need to input a password.

When the acquisition of the user ID fails (NO of S104), the user information acquisition part 12 determines that it is an authentication error. If the user ID is acquired (YES of S104), the user information acquisition part 12 determines whether the card 50 is valid (S105) by referring to a value (valid or invalid) of the card validity related to the current card ID. If the card 50 is invalid (NO of S105), the user information acquisition part 12 determines that it is an authentication error.

If the card 50 is valid (YES of S105), the user information acquisition part 12 determines whether the password is registered with respect to the current card ID in the correspondence information management part 17 (S106). If the password is not registered (NO of S106), the user information acquisition part 12 causes the display part 108 to display a password screen 520 (refer to FIG. 4). After an input button 521 is pressed by the user in the password screen 520 and the password is input (YES of S108), if a cancel button 523 is not pressed (NO of S109) and an OK button 522 is pressed (YES of S110), the authentication control part 13 causes the authentication server 20 to perform an authentication process by sending to the authentication server 20 an authentication request based on the user ID acquired in the step S103 and the password acquired in the step 108 (S112).

On the other hand, if the password is registered with respect to the current card ID in the correspondence information management part 17 (YES of S106), the user information acquisition part 12 acquires the password concerned (S111). Then, the authentication control part 13 causes the authentication server 20 to perform an authentication process by sending to the authentication server 20 an authentication request based on the user ID acquired in step S103 and the password concerned (S112).

If a return from the authentication server 20 indicates a success of the authentication (YES of S116), the password registration part 14 determines whether registration of the password input to the password screen 520 is needed based on a state of a check button 524 in the password screen 520 (S117). If the check button 524 is checked (YES of S117), the password registration part 14 registers the password concerned in the correspondence information management part 17 by relating to the current card ID (S118). On the other hand, if the check button 524 is not checked (NO of S117), the password registration part 14 deletes the password registered with respect to the current card ID in the correspondence information management part 17 (S119). However, if the password is not registered with respect to the current card ID, there is no need to delete the password.

A description is given below of a case where a log-in button 511 is pressed (YES of S114) after the user ID and the password, if it is necessary, are input in the log-in screen 510 (YES of S113) while the card 50 is not set to the card reader 30 (NO of S101) in a state where the log-in screen 510 is being displayed. In such a case, the user information acquisition part 12 acquires the user ID and the password, which were input to the log-in screen 510 (however, if the password is registered with respect to the current card ID, the password concerned is acquired), and the authentication control part 13 requests the authentication server 20 to perform the authentication using the user ID and the password concerned (S115). Then, the process after step S116 mentioned above is performed.

If the return from the authentication control part 13 indicates a failure of the authentication in step S116 (NO of S116), the user information acquisition part 12 determines whether the password used in the authentication is one registered in the correspondence information management part 17 (S120). If the password (hereinafter, referred to as “registered password”) registered in the correspondence information management part 17 is used, information indicating the fact may be recorded in the memory 102 so that the determination of step S120 is made based on the information recorded in the memory 102. If the password used in the authentication is not the registered password (NO of S120), the authentication control part 13 determines that there is an authentication error.

If the password used for the authentication is the registration password (Yes of S120), the user information acquisition part 12 causes the display part 18 to display the password screen 520 to prompt the user to input a new password (S121). Here, the reason for prompting the user to input a password again when the authentication by the registered password is failed is as follows.

In recent years, the password is periodically changed more often for improved security. Therefore, there may occur a case where a password registered in the correspondence information management part 17 is old in spite of the password of the authentication server 20 being updated. In order to simply handle such a case, an opportunity to input a new password (updated password) is given to the user in step S121.

If a password input to the password screen 520 is displayed again, the authentication control part 13 acquires the password input to the password screen 520, and the authentication control part 13 causes the authentication server 20 to perform an authentication process again by sending to the authentication server 20 an authentication request based on the user ID acquired in step S103 and the password concerned (S122).

When a return from the authentication server 20 indicates a failure of the authentication (NO of S123), the authentication control part 13 determines that it is an authentication error. If the return from the authentication server 20 indicates a success of the authentication (YES of S123), the process S after step S117 is performed. Accordingly, if the check button 424 is checked, the password registered in the correspondence information management part 17 is updated by the new password.

If the authentication according to the process of FIG. 3 is completed successfully, the user is permitted to use the image forming apparatus 10. On the other hand, if it is determined that an authentication error occurs, use of the image forming apparatus 10 by the user is restricted.

As mentioned above, the image forming apparatus 10 manages the correspondence information of the card ID and the user ID so that the user ID can be determined based on the card ID. Moreover, the authentication in the image forming apparatus 10 requires an input of not only the set of card ID but also an input of the password. Therefore, even if it is the card 50 in which only the card ID is recorded, an authentication process according to the security level equivalent to the highly efficient IC card, which uses personal identification number (PIN), can be realized.

The image forming apparatus 10 is capable of saving the password in relation to the card ID in order to use the password in the authentication process. Thus, a labor of inputting a password when using the card 50 can be saved, which improves convenience to the user.

Moreover, since an opportunity to input a new password is given to the user during the authentication process even if a mismatch occurs between the registered password and the password managed in the authentication server 20, a consistency of the system can be easily maintained.

A description will be given of a registration process of the ID card in the correspondence information management part 17. The registration process must be performed before performing the authentication (card authentication) using the card 50 as indicated in FIG. 3.

The registration of the card ID is based on a success in the authentication of a user according to the process of FIG. 3. However, in such a case, the card authentication cannot be used. Thus, at least the user ID must be input in the log-in screen 510.

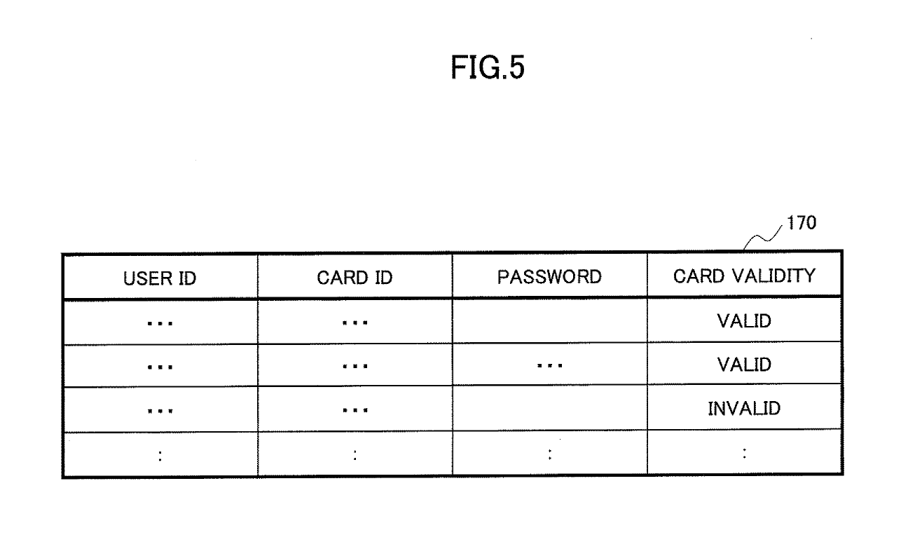

If an authenticated user inputs a registration request of the card ID through the operation part 109, the card ID registration part 15 causes the display part 108 to display a card ID registration screen. FIG. 6 illustrates an example of display of the card ID registration screen. If a card ID acquisition button 531 of the card ID registration screen 530 is pressed, the card ID acquisition part 11 acquires the card ID of the card 50 from the card reader 30, and causes the acquired card ID to be displayed in the card ID registration screen 530. Then, if a registration button 532 is pressed, the card ID registration part 15 registers the card ID concerned in the correspondence information management part 17 by relating to the user ID of the authenticated user.

Thus, in the image forming apparatus 10 according to the present embodiment, each user can register the card ID of his or her own card 50 in the correspondence information management part 17. The registration of the card ID may be performed collectively by a particular person such as a management person, but a load to the management person can be reduced by enabling each user to perform the registration.

The registration of the card validity is performed by a management person or an owner of the card 50 (hereinafter, simply referred to as “user”). Each case is based on the assumption that the user is authenticated by the process of FIG. 3.

In a state where the card 50 is set to the card reader 30, if the authenticated user inputs a registration request of the card validity through the operation part 109, the card validity registration part 16 causes a card validity registration screen to be displayed.

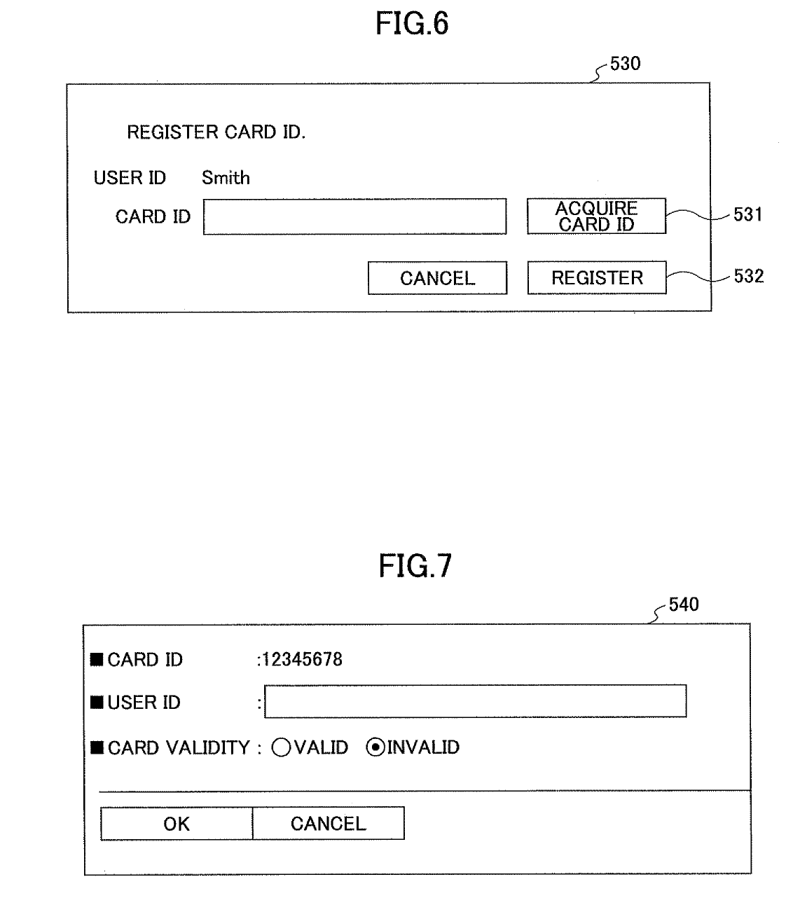

FIG. 7 is an illustration of the card validity registration screen. In FIG. 7, the card ID of the card 50 set in the card reader 30 and the user ID related to the card ID concerned in the correspondence information management part 17 are displayed in the card validity registration screen 540. The card validity (valid or invalid) can be set by a radio button.

If the card validity is set in the card validity registration screen 540 and an OK button 541 is pressed, the card validity registration part 16 registers the card validity in the correspondence information management part 17 by relating to the card ID, which is an object to which the card validity is set.

Thus, by enabling the setting of the card validity, if a user does not use the image forming apparatus temporarily, such as in a case where the user takes a long vacation, an unauthorized use of the card 50 can be prevented properly by temporarily limiting use of the card 50 of the user.

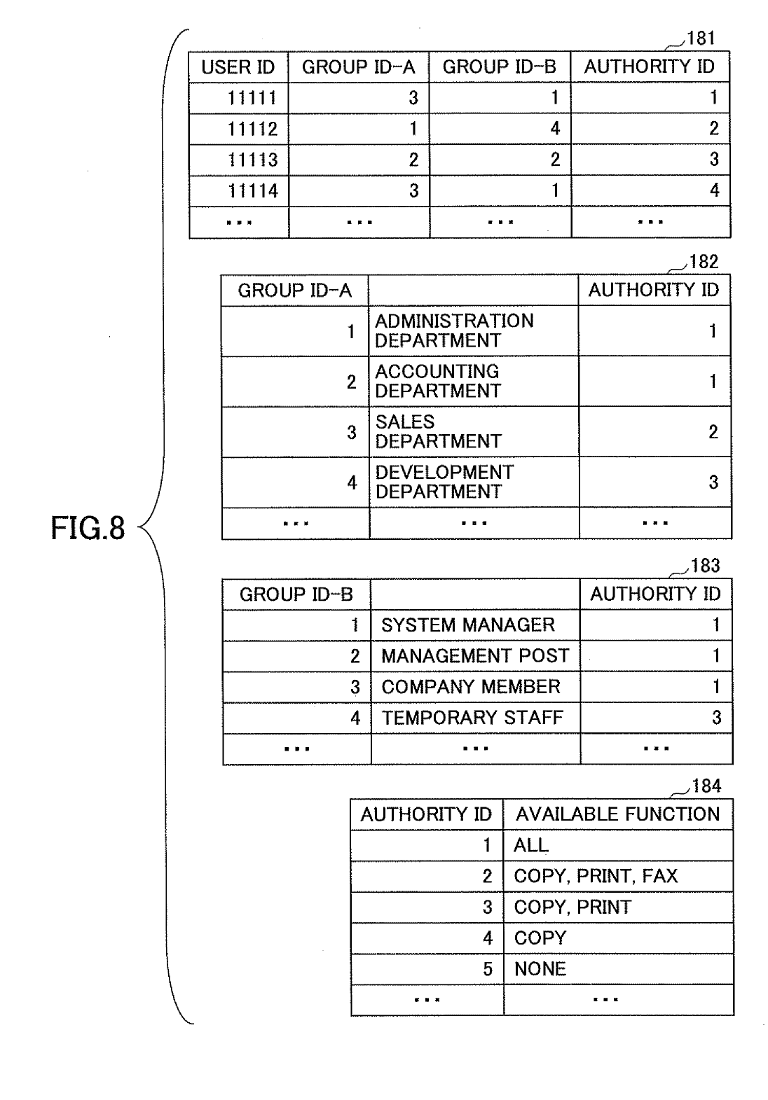

It should be noted that an access control to each function of the image forming apparatus 10 may be performed by using the authentication function using the card 50 mentioned in the present embodiment. For example, FIG. 8 is an illustration of tables used for an access control of the functions of the image forming apparatus 10. Each table illustrated in FIG. 8 is recorded, for example, in the recording medium 103.

A relationship with a group ID for each user (each user ID) and an authority ID for discriminating a use authority to each function of the image forming apparatus 10 are defined in a table 181. In the example of FIG. 8, each user ID is related to the group ID-A or the group ID-B. The Group ID-A is distinguishable according to a section to which each user belongs. The group ID-A is a group ID of a group A. The group A is distinguished according to sections of a company. The group ID-B is a group ID of a group B. The group B is distinguished according to sections of the company.

The authority ID is defined for each group ID (each group ID-A) of the group A in a table 182. The authority ID is defined for each group ID (each group ID-B) of the group B in a table 183. Discrimination information of available functions (scan, copy, print, fax, etc.) are defined for each authority ID in a table 184. The message “all” indicates that all functions are available. The message “none” indicates that no function is available. With respect to copy and print, the authority of use may be divided according to use of a color print. With respect to fax and scan, a limitation may be given so that a value representing a destination of sending an image or saving an image is limited to a previously set value.

By using the tables 181 and 184, the functions which can be used for each user can be limited based on the card 50 distributed to each user. Moreover, by using the tables 181, 182 and 184, the functions which can be used for each section can be limited based on the card 50 distributed to each user. Further, by using the tables 181, 183 and 184, the functions which can be used for each post can be limited based on the card 50 distributed to each user.

For example, if a user authenticated by the authentication process of FIG. 3 selects one of the functions through the operation part 109, the image forming apparatus 10 checks whether the authority of use of the selected function is given to the user concerned in accordance with the tables of FIG. 8. If the authority of use is given to the user, the image forming apparatus 10 causes the display part 108 to display an operation screen of the selected function. If the authority of use is not given to the user, the image forming apparatus 10 causes the display part 108 to display a message such as, for example, “this function is not available” in order to limit the use of the selected function.

Furthermore, not only applications (scan, copy, print, fax, etc.) incorporated as basic functions into the image forming apparatus 10 but also an application developed by a third-party vendor or the like may be authenticated by a single sign-on. Accordingly, for example, a work flow and a display screen may be personalized for each card ID with respect to an application (distribution management tool) which is developed by a third-party vendor and realizes a distribution process of a scanned image.

The above-mentioned authentication control method may be described by a computer readable program and stored in the memory 102 or the recording medium 103 so that the CPU 101 loads the program and performs the authentication control method by executing the computer readable program.

A description will now be given of an image forming apparatus according to a second embodiment of the present invention.

The hardware structure of the image forming apparatus according to the second embodiment is the same as the hardware structure of the image forming apparatus 10 illustrated in FIG. 1, and a description thereof will be omitted.

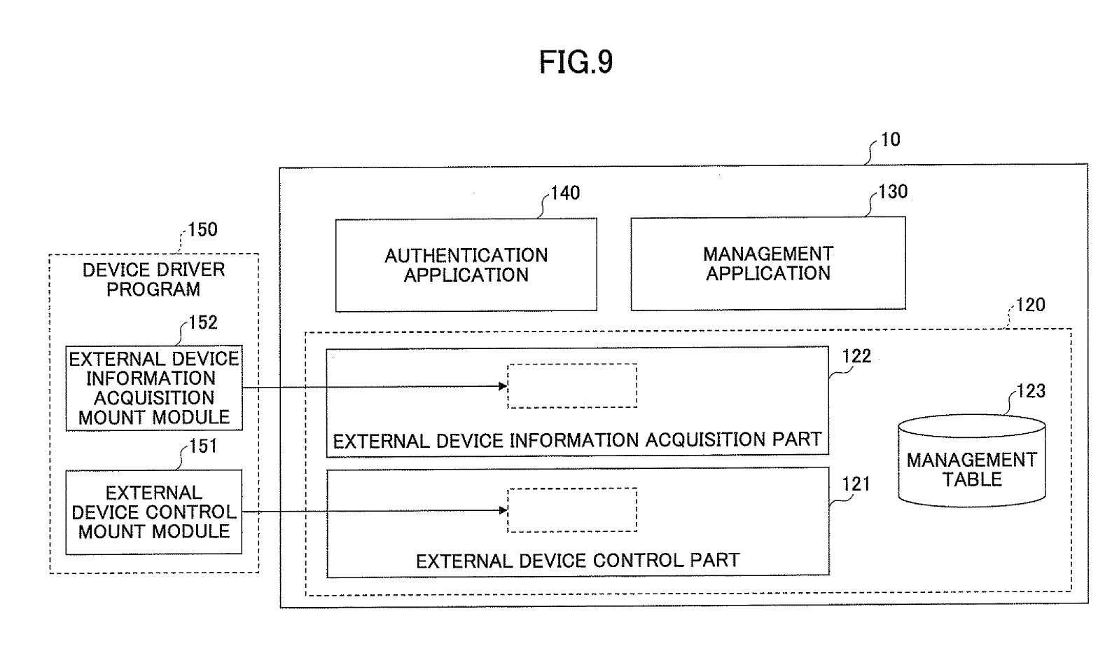

FIG. 9 is a block diagram of a software structure of the image forming apparatus according to the second embodiment of the present invention. In FIG. 9, the software structure of the image forming apparatus 10 includes a device control framework 120, management application 130 and an authentication application 140.

The device control framework 120 is a framework of a control mechanism for connecting the external device 30 to the image forming apparatus 10. In FIG. 9, the device control framework 120 includes an external device control part 121, an external device information acquisition part 122 and a management table 123.

The external device control part 121 controls the external device 30 connected to the image forming apparatus 10 through the external device I/F 107, and performs communication with the external device 30. The external device information acquisition part 122 acquires information (information acquired or input through the external device 30) from the external device 30 through the external device control part 121.

However, the external device control part 121 and the external device information acquisition part 122 as the device control framework 120 merely provide a framework (for example, a common process to various kinds of external devices 30) regarding a control of the external device 30 or acquisition of information from the external device 30. A specific process inherent to each kind of the external device 30 is mounted to a software module (hereinafter, referred to as “logic mount module”) contained in a device driver program 150. In FIG. 9, the device driver program 150 contains logic mount modules such as an external device control mounting module 151 and an external device information acquisition mount module 152.

The external device control mount module 151 is a logic mount module, to which a communication process at an interface level of the external device 30 is mounted, and is registered to the external device control part 121. The external device information acquisition mount module 152 is a logic mount module to which an acquisition process of information from the external device 30 is mounted, and is registered to the external device information acquisition part 122.

The device driver program 150 is a so-called device driver for the external device 30, and mounting contents thereof differ depending on kinds of the external device 30. Accordingly, by installing the device driver program 150 corresponding to the connected external device 30 in the image forming apparatus 10, the external device control mount module 151 and the external device information acquisition mount module 152 can be operated in response to the external device 30. However, each device driver program 150 needs to be mounted according to a predetermined form which the device control framework 120 specifies. That is, the device driver program 150 must be provided with the external device control mount module 151 and the external device information acquisition mount module 152. Moreover, the external device control mount module 151 must be provided with a mount process (an initialization process as a device driver and a process for providing information (identification information) of the device driver program 150 used for relating with the device driver 30) with respect to the interface defined in the external device control part 120. Further, the external device information acquisition mount module 152 must be provided with mounting to the interface specified in the external device information acquisition part 122.

The management table 123 is a table for managing the correspondence information between the installed device driver program 150 and the external device 30, and is recorded, for example, on the recording medium 103. That is, a plurality of device driver programs 150 can be installed in the image forming apparatus 10.

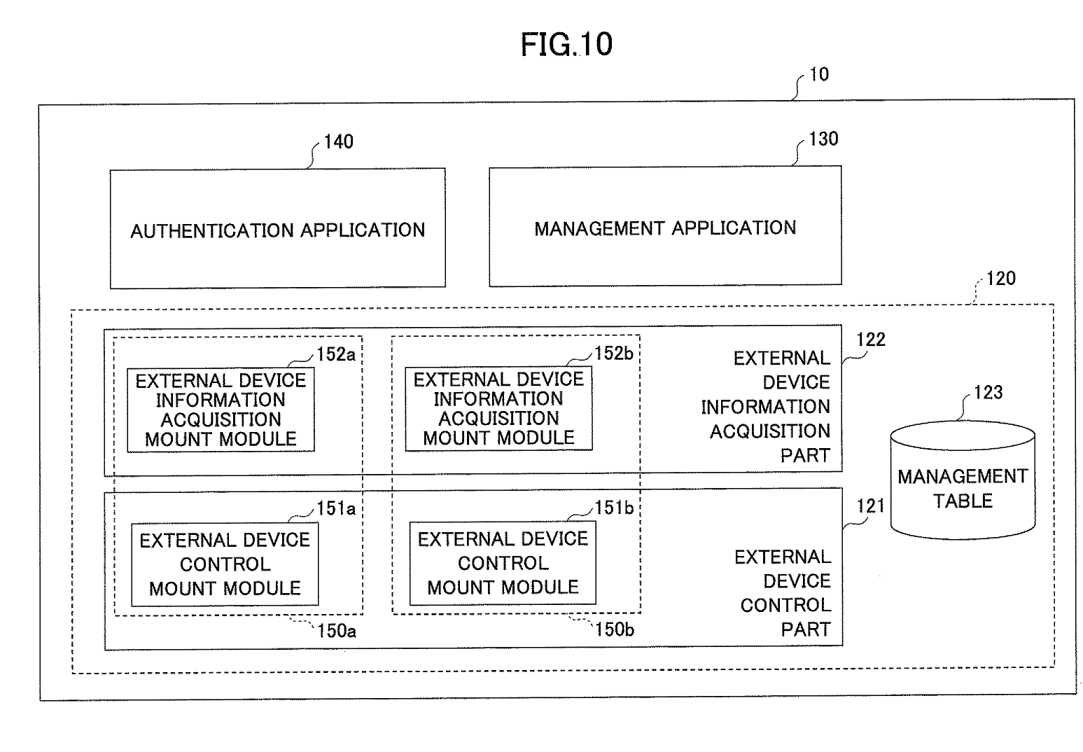

FIG. 10 is a block diagram of the image forming apparatus in which a plurality of device driver programs are installed. In FIG. 10, two device driver programs 150a and 150b are installed. That is, an external device control module 151a of the device driver program 150a and an external device control module 151b of the device driver program 150b are registered in the external device control part 121. Additionally, an external device information acquisition mount module 152a of the device driver program 150a and an external device information acquisition mount module 152b of the device driver program 150b are registered in the external device information acquisition part 122.

The management table 123 manages the correspondence information with the external device 30 with respect to each of the plurality of device driver programs 150 installed.

The management application 130 manages the management table 123. The authentication application 140 performs an authentication process of a user of the image forming apparatus 10 based on the information acquired from the external device 30. That is, the authentication application 140 treats the information acquired from the external device 30 as authentication information of the user.

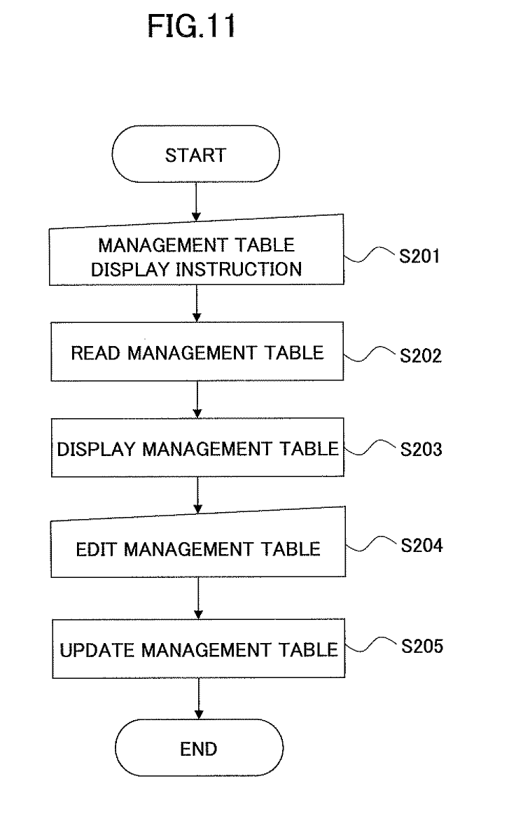

A description will be given below of a process procedure of the image forming apparatus 10. FIG. 11 is a flowchart of an editing process of the management table.

If, for example, a display instruction of the management table 123 is input by a user through the operation part 109 (S201), the management application 130 reads the management table 123 and records the management table 123 on the memory 102 (S202). Then, the management application 130 causes the display part 108 to display the management table 123 recorded on the memory 102 (S203).

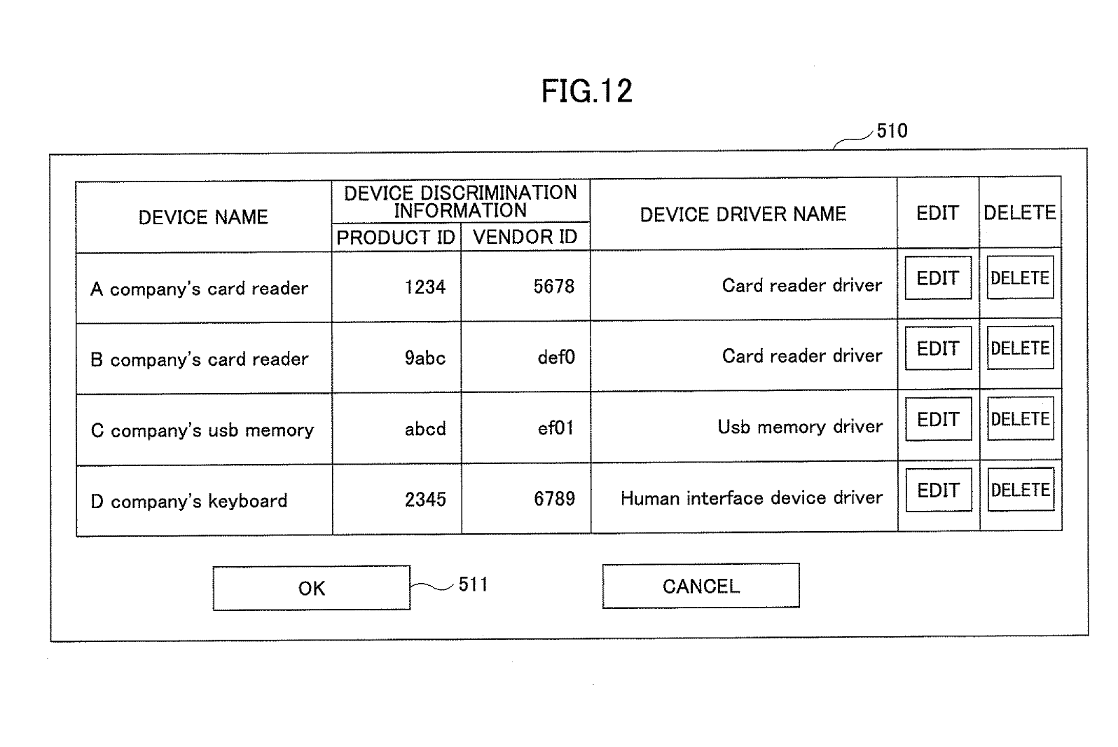

FIG. 12 is an illustration of a first example of display of the management table. A device name, a product ID, a vendor ID, and a device driver name are displayed for each device driver program 150 installed in the image forming apparatus 10 in the management table display screen 510 illustrated in FIG. 12. The device name in the management table display screen 510 is a designation of the external device 30 (for example, a model name). The product ID in the management table display screen 510 is the product ID of the external device 30. The vendor ID in the management table display screen 510 is an identification of the vendor (manufacturer) of the external device 30. In the example of FIG. 12, each external device 30 is uniquely identified by the product ID and the vendor ID. The device driver name in the management table display screen 510 is a name (identification information) of the device driver program 150 corresponding to the external device 30. Information being displayed on the managed table display screen 510 is registered in the management table 123. This point is the same in other examples of the management table display screen 510 explained below.

In the managed table display screen 510, an edit button and a delete button are arranged for each row (each external device 30). If the edit button is pressed, the management application 130 causes the row of the pressed edit button to be in an editable state. Accordingly, the user can change the correspondence relationship between the external device 30 and the device driver program 150 by editing (changing) a value of each item on the row concerned. On the other hand, if the delete button is pressed, the management application 130 deletes the row of the pressed delete button. Accordingly, the correspondence relationship associated with the row concerned is deleted.

When the edit of the management table 123 in the managed table display screen 510 is completed (S204) and an OK button is pressed, the management application 130 updates the management table 123 based on the contents of the edit concerned (S205).

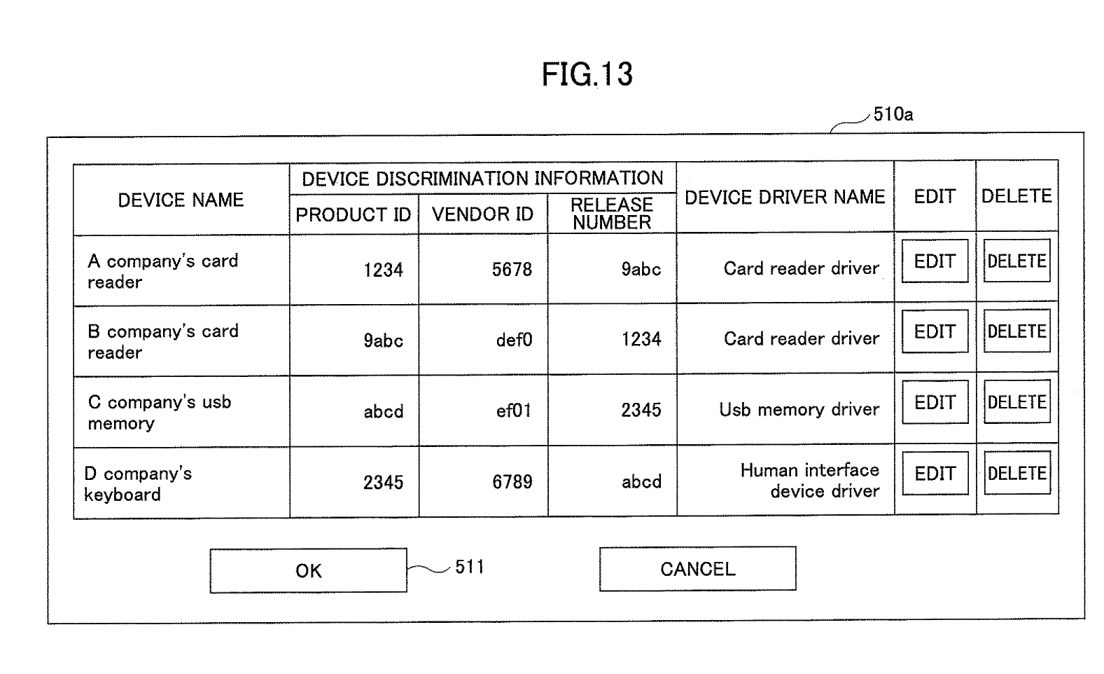

A number of parameters for uniquely identifying the external device 30 may be further increased. FIG. 13 is an illustration of a second example of display of the management table. In the management table illustrated in FIG. 13, a release number is added as one of the parameters to uniquely identify the external device 30. By increasing the number of parameters, the external device 30 can be specified more accurately, and the external device 30 and the device driver program 150 can be related to each other. The release number is an example of a parameter to be added. If the external device 30 can be identified according to other parameters, such a parameter may be managed.

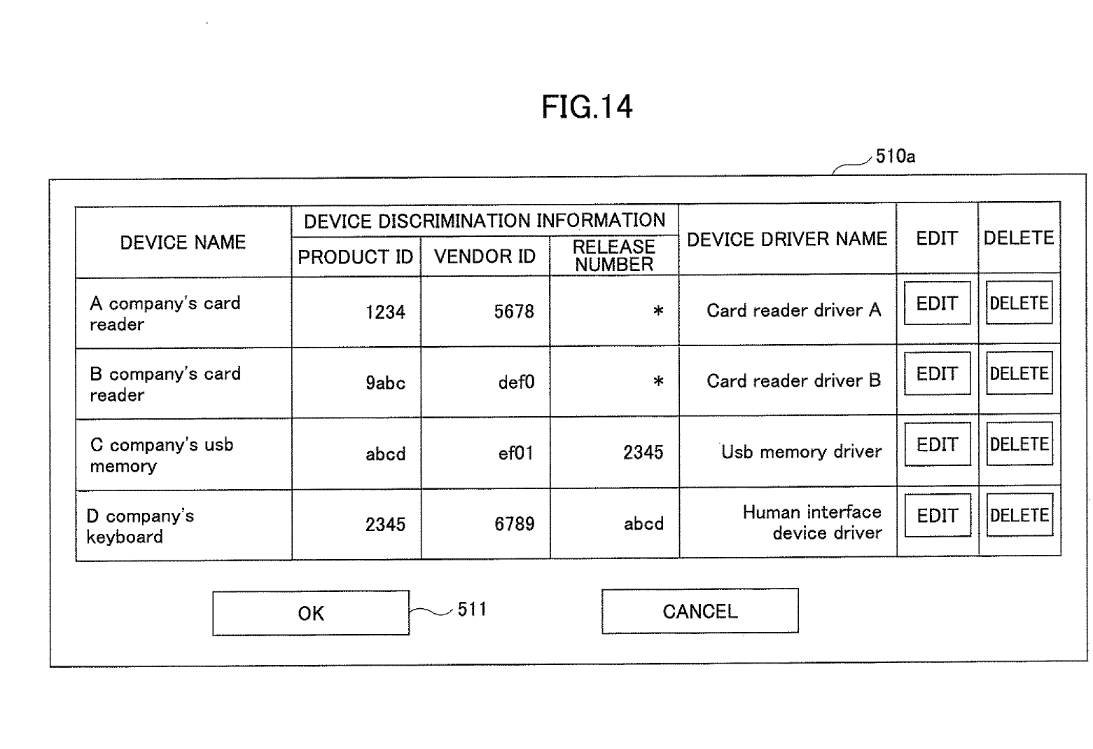

Moreover, in the management table 123, a wild card (a special character meaning arbitrary characters) may be used for the information to identify the external device 130. FIG. 14 is an illustration of a third example of display of the management table.

In the example of FIG. 14, a wild card (“*”) is contained in the release number. By making a wild card usable, flexibility is given to the relating of the external device 30 to the device driver program 150 such that one of the external devices 30 may precisely specify the release number but another one of the external devices 30 may specify only the product ID and the vendor ID. The wild card is not limited to “*”, and an arbitrary character may be used such as, for example, “?”. A wild card may be used also in the product ID or the vendor ID.

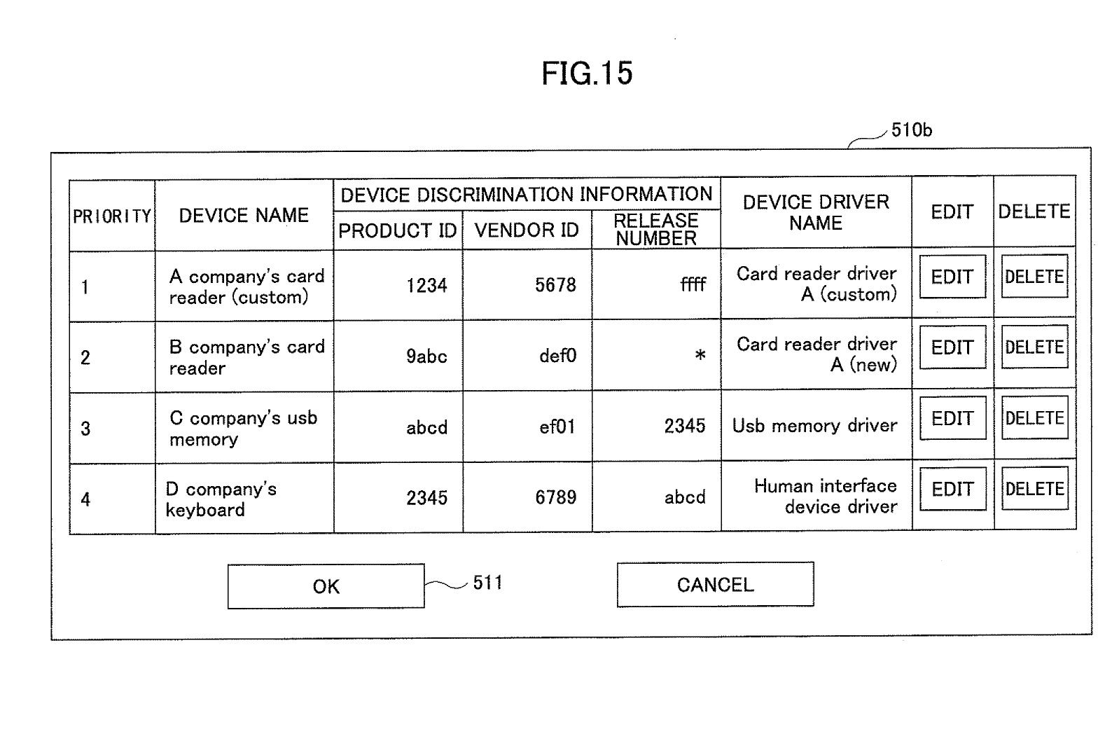

Furthermore, a priority for determining the device driver program 150 corresponding to the external device 30 connected to the image forming apparatus 10 may be registered in the management table 123. FIG. 15 is an illustration of a fourth example of display of the management table.

In a management table display screen 51b illustrated in FIG. 15, a priority is given to each row. If two or more device driver programs 150 are retrieved in determining the device driver program 150 corresponding to the external device 30 connected to the image forming apparatus 10, the device driver program 150 to be used is identified based on the priority (priority order). Because a control is made by only one device driver program 150 when controlling the external device 130, the use of the priority is effective when a wild card is used as in the example of FIG. 14.

The management table display screen 510 (representing the management display screens 510a and 510b) is caused to be displayed by a display device of the client PC 20 (refer to FIG. 1) connected to the image forming apparatus 10 through a network (whichever wired or wireless) so that the management table display screen 510 is editable on the client PC 20. In such a case, a download button may be provided in the management table display screen 510. If the download button is pressed, the management application 130 transfers the management table 123 as a file to the client PC 20. Thereby, the management table 123 can be saved as a backup in the client PC 20.

Moreover, when the management table display screen 510 is displayed on the client PC 20, a management file upload button may be provided in the management table display screen 510. In such a case, if the management file upload button is pressed, the client PC 20 transfers the management table 123 saved in the client PC 20 to the image forming apparatus 10. Upon reception of the management table 123, the management application 130 updates (replaces) the existing management table 123 with the received management table 123. Thereby, the management table 123 can be created according to a CSV format or the like in the client PC 20, which enables saving labor to create the management table 123. Moreover, by combining with the above-mentioned download function, an operation becomes possible to download the management table in one image forming apparatus 10 to the client PC 20 and upload the management table 123 concerned from the client PC 20 to other image forming apparatuses 10. Thus, maintenance of the management table 130 with respect to a plurality of image forming apparatuses 10 becomes easy.

Furthermore, if the management table display screen 510 is displayed on the client PC 20, a driver upload button may be provided in the management table display screen 510. In such a case, if the driver upload button is pressed, the client PC 20 transfers the device driver program 150 saved in the client PC 20 to the image forming apparatus 10. Upon receipt of the device driver program 150, the management application 130 installs the received device driver program 150 therein. Specifically, the external device control mount module 151 contained in the device driver program 150 concerned is registered in the external device control part 121, and the external device information acquisition mount module 152 is registered in the external device information acquisition part 122.

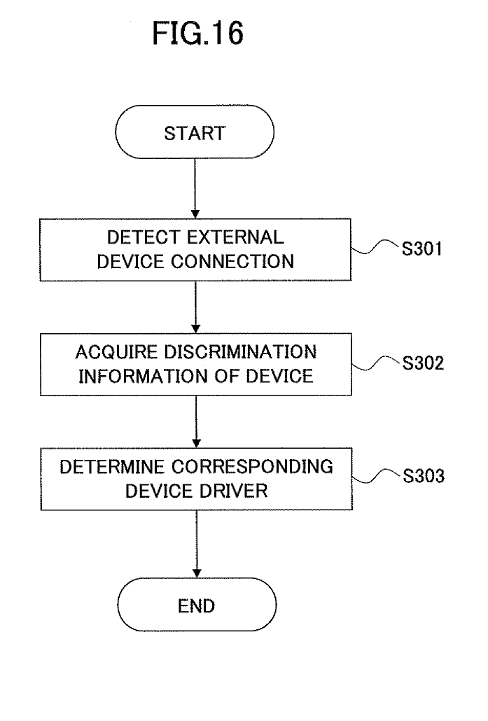

A description will now be given of a process procedure of connecting the external device 30. FIG. 16 is a flowchart of a process of connecting the external device 30.

When the external device 30 is connected through the external device I/F 107, the external device control part 121 detects the connection concerned (S301). In response to the detection of connection of the external device 30, the external device control part 121 acquires the identification information (product ID, vendor ID, release number, etc.) of the external device 30, and notifies the external device information acquisition part 122 of the acquired identification information (S302). The contents of the identification information to be acquired is related to the management table 123. Thereafter, each of the external device control part 121 and the external device information acquisition part 122 determines the device driver program 150 (logic mount module) corresponding to the connected external device 30 based on the identification information of the external device 30 concerned and the management table 123 (S303). At this time, if a wild card is used for the identification information of the external device 30 or if a priority is set up to the device driver program 150, the device driver program 150 corresponding to the connected external device 30 is determined based on those circumstances. Each of the external device control part 121 and the external device information acquisition part 122 stores the identification information of the logic mount module as a determination result in the memory 102. The operation of relating the device driver program 150 and each logic mount module may be performed based on the file name or other correspondence information.

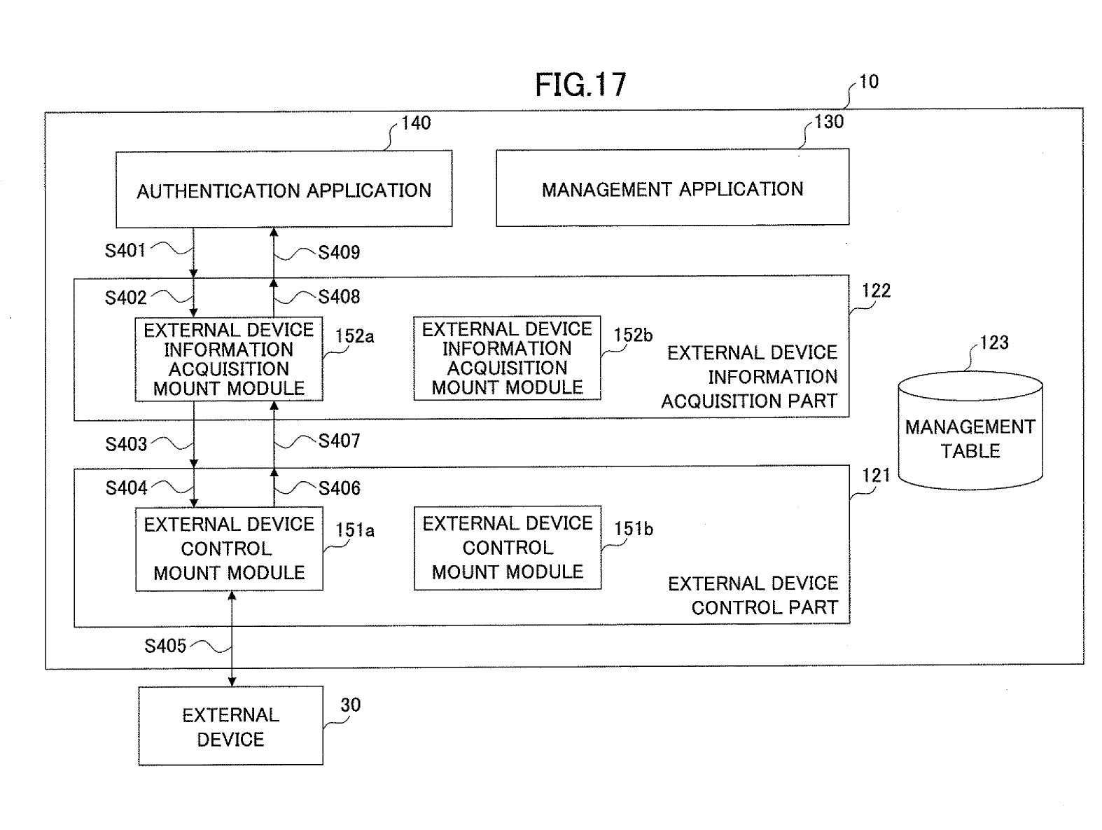

A description is given below of a process procedure when using the device driver program 150. In the present embodiment, as a specific example of the process procedure, a process of the authentication application 140 to acquire authentication information from the external device 130 is used. FIG. 17 is a block diagram of the software structure of the image forming apparatus 10 illustrating a process procedure for acquiring information from the external device 30. In FIG. 17, parts that are the same as the parts illustrated in FIG. 10 are given the same reference numerals.

When authenticating a user, the authentication application 140 requests the external device information acquisition part 122 to acquire information from the external device 30 (S401). At this time, what is necessary for the authentication application 140 is to be conscious of an interface with the external device information acquisition part 122, and there is no need to be conscious of which external device information acquisition mount module 152 is used.

Then, the external device information acquisition part 122 calls the external device information acquisition mount module 152 (suppose that it is the external device information acquisition mounting module 152a) of which identification information as a determination result of the process of FIG. 16 is stored in the memory 102, and instructs the external device information acquisition mount module 152 to acquire the information (S402). Subsequently, the external device information acquisition mount module 152a requests the external device control part 121 to acquire the information from the external device 30 (S403). The external device control part 121 calls the external device control mount module 151 (suppose that it is the external device control mount module 151a) of which identification information as a determination result of the process of FIG. 16 is stored in the memory 102, and instructs the external device information acquisition mount module 152 to acquire the information (S404). The external device control mount module 151a performs communication with the external device 30 at the interface specification level of the external device 30, and acquires the information from the external device 30 (S405). The acquired information is returned to the external device information mount module 152a through the external device control part 121 (S406, S407). The external device information mount module 152a interprets the format of the acquired information according to a recording format corresponding to the external device 30, and returns the information as a result of the interpretation (here, the authentication information) to the authentication application 140 through the external device information acquisition part 122 (S409). Thereafter, the authentication application 140 performs an authentication process using the returned authentication information.

As mentioned above, according to the present embodiment, even if there are many kinds of external devices 30 which the image forming apparatus 10 can user the device driver program 150 corresponding to the connected external device 30 can be appropriately determined and used.

Additionally, the management table 123 for managing the correspondence relationship between the external device and the device driver program 150 can be edited easily by a user.

As mentioned above, the following items are derived from the second embodiment.

1. The image forming apparatus comprising:

a hardware interface through which a plurality of kinds of external devices including said card reader are connected to said image forming apparatus;

a plurality of external device control parts configured to control the plurality of kinds of external devices on an individual kind basis;

a correspondence information management part configured to manage correspondence information between identification information of said plurality of external device control parts and identification information of said external devices;

a correspondence information edit part configured to cause the correspondence information to be displayed on a display device and update the correspondence information in accordance with an input by the user; and

a determination part configured to determine one of said external device control parts corresponding to one of said external devices connected to said hardware interface based on the correspondence information and the identification information of the one of the external devices connected to said hardware interface.

2. The image forming apparatus according to item 1, wherein the identification information of said external devices contains a wild card.

3. The image forming apparatus according to item 1, wherein the correspondence information contains a priority with respect to each of said external device control parts, and said determination part determines that one of said external device control parts having a highest priority corresponds to said one of external devices connected to said hardware interface.

4. An external device management method performed by an image forming apparatus connectable to a plurality of kinds of external devices through a hardware interface, the external device management method comprising:

causing correspondence information to be displayed on a display apparatus, the correspondence information representing a correspondence between identification information of a plurality of external device control parts and identification information of said external devices, the external device control part controlling said external devices on an individual kind of said external devices basis;

updating the correspondence information in accordance with the input by the user; and

determining one of said external device control parts corresponding to one of said external devices connected to said hardware interface based on the correspondence information and the identification information of the one of the external devices connected to said hardware interface.

5. The external device management method according to item 4, wherein the identification information of said external devices contains a wild card.

6. The external device management method according to item 4, wherein the correspondence information includes information representing a priority level to each of said external devices, and said determining determines that one of said external devices having a higher priority level than other external devices corresponds to said one of said external devices connected to said hardware interface.

7. A computer readable program for causing an image forming apparatus, which is connectable to a plurality of kinds of external devices through a hardware interface, to perform an external device management method comprising:

causing correspondence information to be displayed on a display apparatus, the correspondence information representing a correspondence between identification information of a plurality of external device control parts and identification information of said external devices, the external device control part controlling said external devices on an individual kind of said external devices basis;

updating the correspondence information in accordance with the input by the user; and

determining one of said external device control parts corresponding to one of said external devices connected to said hardware interface based on the correspondence information and the identification information of the one of the external devices connected to said hardware interface.

8. The program according to item 7, wherein the identification information of said external devices contains a wild card.

9. The program according to item 7, wherein the correspondence information includes information representing a priority level to each of said external devices, and said determining determines that one of said external devices having a higher priority level than other external devices corresponds to said one of said external devices connected to said hardware interface.

The present invention is not limited to the specifically disclosed embodiments, and variations and modifications may be made without departing from the scope of the present invention.

The present application is based on Japanese priority applications No. 2008-143134 filed May 30, 2008 and No. 2008-143135 filed May 30, 2008, the entire contents of which are hereby incorporated herein by reference.

What is claimed is:

1. An image forming apparatus comprising:
an ID acquisition part configured to acquire a card ID readable by a card reader;
a correspondence information management part configured to manage correspondence information between said card ID and user identification information;
a user information acquisition part configured to acquire the user identification information corresponding to said card ID acquired by said card ID acquisition part from said correspondence information management part, and acquire a password of a user corresponding to the acquired user identification information; and
an authentication control part configured to cause an authentication process of the user to be executed in accordance with the acquired user identification information and the acquired password.

2. The image forming apparatus according to claim 1, wherein said user information acquisition part acquires the password that is input through an input part provided in the image forming apparatus.

3. The image forming apparatus according to claim 2, further comprising a password registration part configured to register the password, which is input through said input part, in said correspondence information management part in correspondence with said card ID.

4. The image forming apparatus according to claim 3, wherein said user information acquisition part acquires the password, which corresponds to said card ID acquired by said card ID acquisition part, from said correspondence information management part.

5. The image forming apparatus according to claim 1, further comprising a card ID registration part configured to register said card ID read by said card reader in said correspondence information management part in correspondence with the user identification information when the user is authenticated by the authentication process, which said authentication control part causes to be executed, in accordance with the user identification information and the password input through the input part provided in the image forming apparatus.

6. The image forming apparatus according to claim 3, wherein said password registration part updates the password registered in said correspondence information management part with a new password input through said input part when the authentication by the password input through the input part fails and the user is authenticated by the authentication process using the new password.

7. The image forming apparatus according to claim 1, further comprising a card validity registration part configured to register information indicating a validity of said card, which information is set through said input part provided in the image forming apparatus, in said correspondence information management part in correspondence with said card ID.

8. An authentication control method performed by an image forming apparatus, comprising:
acquiring a card ID readable by a card reader;
acquiring user identification information corresponding to the acquired card ID from a correspondence information management part, which is configured to manage the correspondence information between said card ID and the user identification information, and acquiring a password corresponding to the acquired user identification information; and
causing an authentication process of the user to be executed in accordance with the acquired user identification information and the acquired password.

9. The authentication control method according to claim 8, wherein the acquiring the user identification information acquires the password that is input through an input part provided in the image forming apparatus.

10. The authentication control method according to claim 9, further comprising registering the password, which is input through said input part, in said correspondence information management part in correspondence with said card ID.

11. The authentication control method according to claim 10, wherein the acquiring the user identification information acquires the password, which corresponds to the acquired card ID, from said correspondence information management part.

12. The authentication control method according to claim 8, further comprising registering said card ID read by said card reader in said correspondence information management part in correspondence with said user identification information when the user is authenticated by the authentication process in accordance with the user identification information and the password input through an input part provided in the image forming apparatus.

13. The authentication control method according to claim 10, further comprising updating the password registered in said correspondence information management part with a new password input through said input part when the authentication by the password input through said input part fails and the user is authenticated by the authentication process using the new password.

14. The authentication control method according to claim 13, further comprising registering information indicating a validity of said card, which information is set through said input part provided in the image forming apparatus, in said correspondence information management part in correspondence with said card ID.

15. A computer readable recording medium storing a computer readable program causing a computer to perform an authentication control method, the authentication control method comprising:
acquiring a card ID readable by a card reader;
acquiring user identification information corresponding to the acquired card ID from a correspondence information management part, which is configured to manage the correspondence information between said card ID and the user identification information, and acquiring a password corresponding to the acquired user identification information; and
causing an authentication process of the user to be executed in accordance with the acquired user identification information and the acquired password.
